(19) United States
(12) Patent Application Publication
(10) Pub. No.: US 2006/0269688 A1
(43) Pub. Date: Nov. 30, 2006

(54) Electrochemical method for the direct nanostructured deposition of material onto a substrate, and semiconductor component produced according to said method

(75) Inventors: Sascha Sadewasser, Berlin (DE); Thilo Glatzel, Inzlingen (DE); Martha Lux-Steiner, Berlin (DE)

Correspondence Address: LAW OFFICES OF KARL HORMANN, 86 SPARKS STREET, CAMBRIDGE, MA, 02138, US

(73) Assignee: HAHN-MEITNER-INSTITUT BERLIN GMBH, Berlin (DE)

(21) Appl. No.: 10/553,102

(22) PCT Filed: Apr. 7, 2004
(86) PCT No.: PCT/DE04/00748

§ 371 Date: Apr. 28, 2006

(30) Foreign Application Priority Data
Apr. 15, 2003 (DE) 103 18 440.6

(51) Int. Cl. B05D 3/00; H05H 1/24; C23C 8/00

(52) U.S. Cl. 427/561; 427/569; 427/585

(57) ABSTRACT

A method of fabricating a nano-scaled semiconductor by depositing upon a substrate, within the confines of a narrowly limited electric field, from an adjustable mixture of precursor gases containing different precursor compounds, nano-scaled deposits of common chemical compounds released in consequence of the precursor compounds breaking down upon the simultaneous or sequential application of a voltage exceeding a predetermined threshold value.

### BACKGROUND OF THE INVENTION

1. Field of the Invention

The invention relates to an electrochemical method of direct nano-structured deposition of a material onto a substrate by precipitation of at least one material component from a temperature and pressure controlled atmosphere including at least one precursor gas containing the material component in a precursor compound, under the influence of a locally narrowly limited electric field built up as a function of voltage and time between a moveable electrically conducting tip of a probe of a touchless scanning microscope and the substrate, with the precursor compound breaking down above a predetermined voltage threshold value and the separated material component being deposited on the substrate in the area of the tip of the probe, and to a semiconductor component fabricated by the method.

2. The Prior Art

The use of scanning probe microscopes, e.g. scanning tunnel microscopes (STM) or scanning force microscopes (SFM. or AFM) makes possible the specific manipulation of matter on an atomic scale which is especially important in the context of the miniaturized (range of micrometer as well as nanometer) fabrication of electronic circuits and components. In this connection, a distinction is made between ablating and depositing processes. Structuring by conventional lithographic methods is not possible at dimensions below 100 nm. Since ablating processes are not reversible, deposition processes are increasingly of interest. Different processes have become known in the prior art. For instance, a semiconductor or metal substrate wetted by a coating of water as the electrolyte is locally oxidized (local anodic oxidation=LAO) by the influence of the tip of a probe of a scanning force microscope charges to a potential with respect to the substrate. Furthermore, it is known locally to precipitate a metallic structure on a metallic substrate, by locally activating the substrate prior to the deposition by mechanical contact with the tip of a probe. In nano-structured imprint lithography (NIL), printed metal-semiconductor-metal structures are melted and pressed into a superposed layer of synthetic material and subsequently pulled off. This process, though operating without a probe tip, may be used for fabricating photo diodes of lateral dimensions below 10 nm.

Aside from the large-surface electro-deposition of precipitating metals onto substrates, the STM-CVD method (scanning tunneling microscopy assisted chemical vapor deposition) is also known from the prior art, in which a locally narrowly restricted deposition of a material component takes place in a solid condition, which has been separated from a gaseous precursor compound by the influence of a locally narrowly limited electric field between the tip of a probe and the substrate. In this process, the substrate is not itself a reaction partner (unlike in the LAO), but it only functions as a mechanical support. In respect of this generic concept, the closest prior art upon which the instant invention is based has been described in Publication I by F. Marchi et al. In “Direct patterning of noble metal nano-structures with a scanning tunneling microscope” (J. Vac. Sci. Technol. B 18(3), 2000, pp. 1171-1176. The known process serves for precipitating noble metal traces onto a substrate. For this purpose, a precursor gas is used which contains a noble metal, e.g. gold, iridium or rhodium as the material component in a precursor compound (see in particular FIG. 1 of Publication I). In an atmosphere sealed in a pressure-tight manner (vacuum chamber) the precursor gas is guided between the gap between the electrically conductive tip of the probe of a STM, which does not touch the substrate, and the substrate, .e. a silicon substrate. By serial generation of a plurality of voltage pulses above a predetermined threshold value at room temperature there take place a separation of the precursor compound in the locally limited area of the tip of the probe and, hence, a release of the material component to be precipitated. It will deposit itself on the substrate in the vicinity of the tip of the probe. In this known process, there takes place a breakdown of the precursor compound in the precursor gas. The released material component is deposited on the substrate without any further chemical reaction taking place. It is known from Publication II by I. Lyubinetsky et al. in “Two mechanisms of scanning tunneling microscopy assisted nano-structure formation using precursor molecules” (S. Vac. Sci. Technol. B 17(4), 1999, pp. 1445-1450) also to deposit individual semiconductor materials by the STM-CVD process. This publication discloses in particular the chemo-physical reasoning for the application of the STM-CVD process. A distinction is made between two process stages. In the first stage of the process, there takes place a breakdown of the molecules in the precursor gas by the addition of electrons from the electric field. In the second stage, the released material component is precipitated in very small clusters but without any further chemical reaction in the electric field under the effect of the field-induced surface diffusion, with the substrate having previously coated with a molecular layer from the precursor gas. Hence, in every known process only one precursor gas with a single precursor compound in it is injected into the atmosphere above the substrate to be structured. Under the influence of the electric field the precursor compound in the precursor gas breaks down, and a single element is precipitated on the substrate.

In summary, the following process parameters are disclosed by the STM-DVD processes of the prior art (the table is not to be understood as being complete) (the abbreviations have the following meaning: “D”=Di; “T”=Tri; M=Methyl; “E”=Ethyl; B=Butyl; etc.
precipitable materials: Cd, Si, Au, W, Mo, Cu, Ir, Rh, Fe, Ni
precursor gases used: DMCd, DCS (dichlorosilane), SiH₄, W(CO)₆, Mo(CO)₆, Ni(CO)₄, Cu¹(hfac)(vtms), Fe(C₅H₅)₂
pressure of the precursor gases: 10⁻⁵ Pa-1 Pa
flowing current tip of probe-substrate: 10 pA-10 nA
applied voltage tip of probe-substrate: −100V to +20V where a threshold value of ±1.7 V must be exceeded
duration of current pulse 10 ns-6 min
process temperature: room temperature (=300° K)

### OBJECT OF THE INVENTION

Proceeding from the described characteristic that by known STM-CVD processes only one single material component can be deposited, the object of the present invention is thus to be seen in so to structure the generic process as also to make possible the deposition on the substrate of chemical compounds. The process is, however, to retain its simplicity and precision in the formation of nano-scaled structures. Yet it is to be carried out flexibly so as to make possible the deposition of different chemical compounds in one process operation. In structural components fabricated according to the process of the invention, the possibility of precipitating compound semiconductors and the high flexibility inherent in it is also to be realized.

### SUMMARY OF THE INVENTION

In the accomplishment of this object, the electrochemical process of direct nano-structured material deposition on a substrate of the kind referred to supra thus provides, in accordance with the invention, for the simultaneous or sequential use of a plurality of precursor gases each of a different precursor compound containing a different material component in a gas mixture of an adjustable mixing ratio, and for material components separated from the different broken-down precursor compounds to form, in correspondence with the selected mixing ratio, a common chemical compound which is locally deposited on the substrate.

In the method of the invention, the two known process stages are significantly broadened and a further process stage is added. By the simultaneous or sequential use of several precursor gases (or as equivalent to the simultaneous use by the use of a mixed precursor gas with several precursor compounds each of which contains a different material component) it is not now only one material compound which in the gas phase of the first process stage is separated in the locally limited electric field from its corresponding precursor compound, but rather several material components from their respective precursor compounds. These separated material components do not then, however, precipitate on the substrate directly as simple clustered molecules, but under the effect of the electric field between the tip of the probe and the substrate they either react with each other during the gas phase already or after their precipitation of the substrate. This new process stage, newly added by the method in accordance with invention, a material is formed in a common chemical compound. Rather than this compound, the precursor gases previously contained its individual components only. However, the compound formed by the chemical reaction is sufficiently stable to be precipitated as an independent material on the substrate under the spatially limited effect of the electric field. The volume of the precipitated material relating to the tip of the probe is defined in a well-known manner by the size, duration and type of voltage between the tip of the probe and the substrate. Furthermore, the localized precipitation may be directly limited to the size of the tip of the probe and thus be dimensioned down to the range of nanometers. However, larger structures may also be fabricated by controlled movement of the tip of the probe during the precipitation process. The composition of the precipitated material is determined by the ratio of the material components in the gas mixture and by the partial pressure. Therefore, the process in accordance constitutes a novel method of material fabrication in which, simultaneously with the fabrication, mesoscopic structures and, more particularly, nano-structures can be fabricated from the material.

Because of their special and adjustable conductive properties, compound semiconductors (e.g. II-IV, III-V and their derivatives I-III-VI₂ and II-IV-V2) are of special importance in electronic circuit and structural component technology. Free semiconductor materials can already be precipitated by the known STM-CVD process. The fabrication especially of nano-structures such as nano-dots (so-called “quantum dots”) and nano-lines now leads to novel electronic structural components (e.g. single electron transistors) of quantum-physical characteristics which yield a number of advantages and which may be used in new ways. Compound semiconductors are of particular significance in connection with light-sensitive reactions and, therefore, they are particularly suitable for the production of opto-electronic and photo-electronic components. In accordance with an improvement of the method in accordance with the invention it is, therefore, advantageous to use elements of the chemical groups V and VI which react with other material components of groups I, II, III and/or IV to a compound semiconductor as a common chemical compound. Depending upon the number of material components used, it is thus possible to form binary, tertiary, quaternary and even pentanary or high compounded reaction products. In accordance with a further embodiment of the invention, chalco-pyrite from the material system (Cu, Ag)(Ga, In, Al)(O, S, Se)₂ may be formed as the compound semiconductor. Compared to the often used silicon, chalco-pyrite compound semiconductors are characterized by a markedly higher light absorption which at an identical photosensitivity results in a lesser consumption of material and to smaller structures.

Applications exist in the biological sector as well as in other fields which require a spectral sensitivity, i.e. a sensitivity of the semiconductor components, to different wavelengths. Owing to its sensitivity caused by the variable bandwidth at a partial substitution of individual material components, the chalco-pyrite material system (Cu, Ag)(Ga, In, Al)(O, S, Se)₂ [I-III-IV₂-compound semiconductor] is particularly suitable for the fabrication of corresponding structural components. In accordance with a further embodiment of the invention, the partial substitution can advantageously be attained by chronologically varying the use of the precursor gases and/or their mixing ratio in the gas mixture during the precipitation process. By changing the mixing ratio during the precipitation process, the same material components contribute to the formation of the common chemical compound albeit in varying concentrations. The mixing ration can be changed by changing the proportions of the precursor gases and, therefore, by changing the partial pressures. Furthermore, it is possible during the precipitation process to exchange individual material components. It is thus possible by the method, in an extremely simple manner and by single process operation to change the type of contributing material components (conductive or semi-conductive) as well as their concentration in the common chemical compound for fabricating different material compound structures. In accordance with a further embodiment of the invention, the variations of the parameters as well as the variations of the electric field strengths referred to supra can be determined and controlled by a computer as a function of the common chemical compound to be precipitated. Furthermore, in the method according to the invention, the substrate contributes no components to the precipitated material and only satisfies supportive and electronic functions as may be required, for instance, when sorting electrical signals. Hence, in terms of their strength and surface morphology almost any substrates may be used. More particularly, aside from using rigid substrates, it would be possible, according to a further embodiment of the invention, also to use flexible substrates. This would broaden the field of possible applications.

It is possible by the method in accordance with the invention to precipitate, on a substrate, nano-dots or nano-lines consisting of II-IV, III-V, or even I-III-VI₂, II-IV-V₂ etc. semiconductors. Examples to be mentioned are: CdSe, ZnSe, ZnS, GaAs, InP, GaAIAsP, CuGaSe₂, CuInS₂. For this purpose known precursor compounds are use in the precursor gases constituting the gas mixture, for instance for providing the individual material components from (the table is not complete):

| | |
|---|---|
| Group-I-elements: | Cu¹(hfac)(vtms) [=hexafluoroacetyl acetonate |
| | Cu(I) vinyl trimethylsilane] |
| Group-II-elements: | DMZn, DEZn, DMCd, DECd |
| Group-III-elements: | TMAl, TEAi, TMGa, TEGa, TIBGa, TMIn |
| Group-IV-elements: | SiH₄, GeH₄ |
| Group-V-elements: | PH₃, AsH₃, DMAs, TMAs, DEAs, TBAs and |
| Group-VI-elements: | DMTe, DMDTe, DMS, DES, MSH, |
| | (methylmercaptan), DESe, C₄H₄Se, H₂S, H₂Se |

The method in accordance with the invention with its possibility of precipitating on a substrate compound materials derived from a chemical reaction in almost any structures may be applied in variegated ways in the most diverse applications. Photo-electric applications have been alluded to supra in which the light-sensitivity of the fabricated structures is important. Aside from the light-absorbing property of compound semiconductors, applications in which light is emitted is also important, for instance in light emitting diodes (LED) or semiconductor lasers. An electronic semiconductor component which is preferably fabricated by the electrochemical method described above, may thus advantageously be structured as a light absorbing photo-diode or as a light-emitting diode or as an array of either of them. The diodes may advantageously be precipitated in a structured manner as light-absorbing or light-emitting compound semiconductors. Since the color of the absorbed or emitted light is determined by the bandwidth of the material, it can be advantageously set by the composition of the precipitated compound semiconductor. Furthermore, for multifarious applications an array structure is advantageous with photo and/or light emitting diodes of different spectral absorption or emission characteristics. Such an array may have a uniformly repetitive structure of several photo diodes and/or light emitting diodes. Finally, the array may also be structured as a compact module if an insulating oxide layer is advantageously placed between the individual photo diodes and/or light emitting diodes and if a semiconductive cover layer of is provided with a charge conductivity opposite that of the photo diodes and or light emitting diodes.

For example, a nano-scaled photo diode array may be used in biotechnology which could operated as an artificial retina in the human eye if applied to a biological or biologically compatible substrate. In this connection, semiconductor components would be particularly advantageous which are fabricated by the electrochemical method in accordance with the invention and which are structured as a photo diode array from nano-scaled photo diodes of different spectral sensitivity in which the individual nano-sized photo diodes are formed by closely adjacent precipitation of nano-dots from variable gas mixtures containing semiconductive chalco-pyrites. The precipitation may be carried out on a substrate having a charge conductivity opposite that of the nano-dots so that the individual photo diodes remain freely contactable. It is, however, also possible subsequently to insulate the nano-dots, e.g. by proving insulating oxidation in the interstices between the nano-dots. In that manner, the contacts with the nano-sized photo diodes would be preformed. Furthermore, a regularly repetitive structure of at least three nano-sized photo diodes of different spectral sensitivity can be realized. In particular, the three nano-sized photo diodes may be of the spectral sensitivity of the three primary colors blue, green and red.

### DESCRIPTION OF THE SEVERAL DRAWINGS

The novel features which are considered to be characteristic of the invention are set forth with particularity in the appended claims. The invention itself, however, in respect of its structure, construction and lay-out as well as its manufacturing techniques, together with other advantages and objects thereof, will be best understood from the following description of preferred embodiments when read in connection with the appended drawings, in which:

FIGS. 1a . . . c depict the process stages of the method in accordance with the invention; and

FIGS. 2a . . . d is top elevation of the fabrication of the an array of photo diodes.

### DETAILED DESCRIPTION OF THE PREFERRED EMBODIMENTS

Hereafter, two examples are described for precipitation by the method in accordance with the invention of nano-scaled semiconductor structures at room temperature, which set forth the different definitions of the process parameters (the selected precursor gases, the pressure in the precipitation chamber, the mixing ratio of the precursor gases, the voltage between the tip of the probe and the substrate, the tunnel current, the height of the voltage pulse, the duration of the voltage pulse). In individual cases, the definition of individual process parameters will always be dependent upon the precipitated chemical compound and may individually be easily arrived at by carrying out a limited number of tests.

### EXAMPLE (I)

### Nano-Structuring of Cadmium Telluride CdTe

Used precursor gases with precursor compounds DMCd and DETe. The precipitation chamber (for instance that of an STM) is charged with precursor gases from a basic pressure of p<10⁻⁷ Pa to a pressure of 5*10⁻² Pa (through-flow of gases) with a mixing ratio of DETe:DMCd=2 being set during the gaseous phase. The STM is operated at a voltage of −1V at the substrate and a tunnel current of 2 nA. By a voltage pulse of +5V at the tip of the probe and a duration of 1 s, the different precursor compounds in the precursor gases are broken down and the release of the requisite material components Cd and Te and their reaction into the chemical compound CdTe in the narrowly limited area beneath the tip of the probe are achieved. The CdTe is deposited on the substrate below the tip of the probe.

### EXAMPLE (II)

### Nano-Structuring of Copper Gallium Diselenide CuGaSe2

Used precursor gases with precursor compounds: Cu(hfac)(vtms), TEGa, DTBSe.

The precipitation chamber (for instance of an STM) is filled by the precursor gases from a basic pressure of p<10⁻⁷ Pa to a pressure of 10⁻² Pa (through-flow of gases) and the mixing ratio is set of Cu¹(hfac)(vtms):TEDa:DTBSe=1:1:100. The STM is operated at a voltage of −1V at the substrate and a tunnel current of 1 nA. By a voltage pulse of −7V and about 5 min duration at the tip of the probe the different precursor compounds in the precursor gases are broken down and the release of the requisite material components Cu, Ga and Se and their reaction into the common chemical compound CuGaSe₂ is achieved in the narrowly limited area below the tip of the probe. The chemical compound is deposited on the substrate below the tip of the probe.

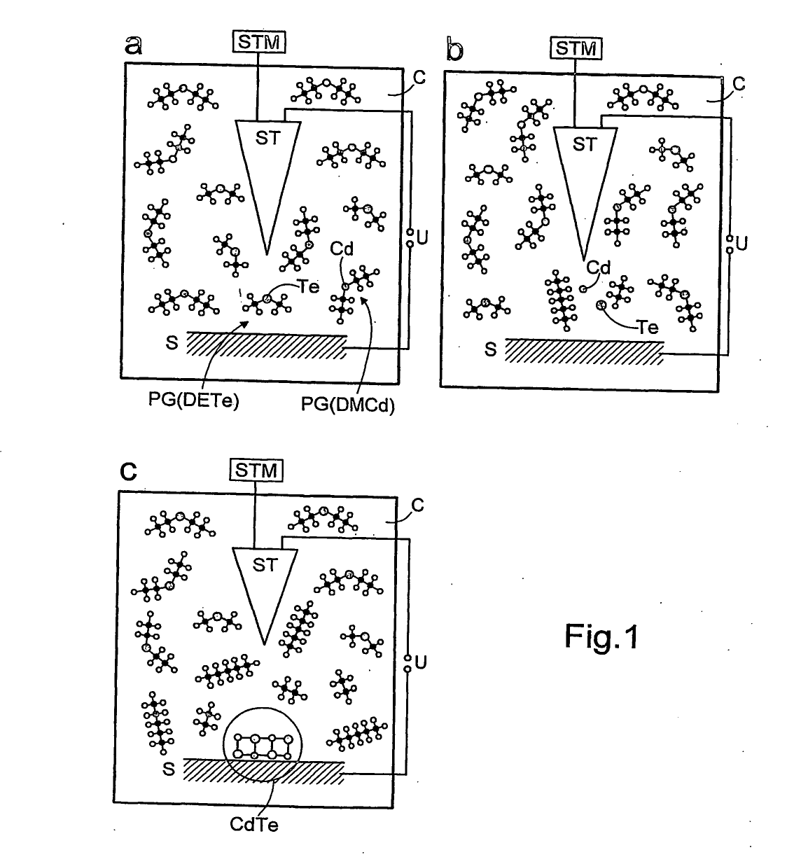

The individual process stages in the described examples are shown in greater detail in FIG. 1 relating to Example 1. A mechanical tip of a probe ST such as, for example, from a scanning tunneling microscope STM, is shown above a substrate S. In a precipitation chamber C sealed in a pressure tight manner (precipitation is also possible at normal pressure or flow-through conditions) the precursor gases PG DMCd and DeTe with the requisite material components Cd and Te are present in the vicinity of the tip of the probe ST (FIG. 1a). FIG. 1b shows the release of the material components Cd and Te from their respective precursor compounds by application of a voltage U between the tip of the probe ST and the substrate S. FIG. 1c depicts the precipitation of CdTe on the substrate S in the narrowly limited area of the tip of the probe ST. The chemical reaction of the material components Cd and Te released as shown in FIG. 1b into the semiconductive compound cadmium telluride CdTe may have taken place during the gaseous phase or after precipitation on the substrate S under the effect of the tip of the probe ST.

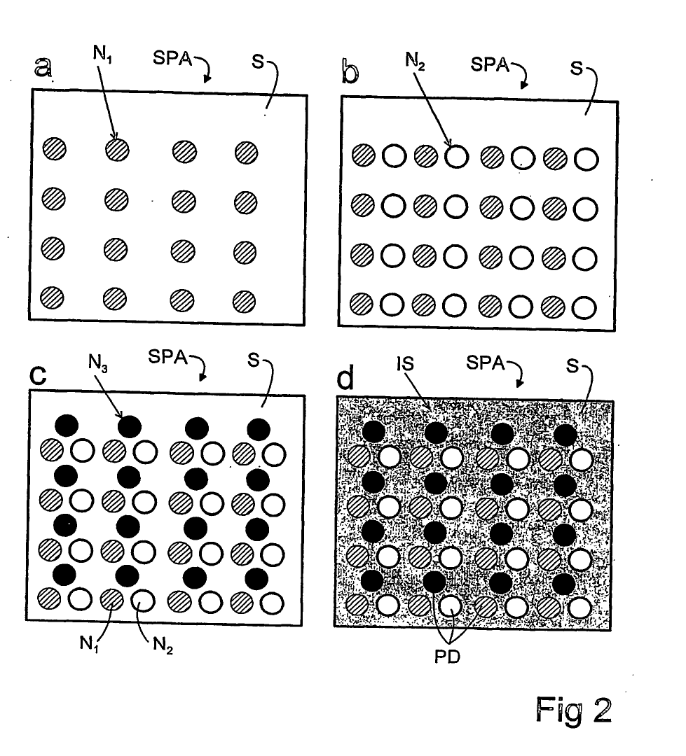

FIG. 2 schematically depicts the process of fabricating a spectrally sensitive photo diode array SPA. In the embodiment selected, three types of nano-scaled photo diodes PD of different spectral sensitivity are fabricated:
hatched circles: CuGaSe₂ with E_{g}=2.5 eV of spectral sensitivity “blue”;
white circles: CuGa(Se, S)₂ with E_{g}=2.2 eV of spectral sensitivity “green”;
black circles: Cu(In, Ga)Se₂ with E_{g}=1.5 eV of spectral sensitivity “red”.

In a first stage (FIG. 2a) first nano-dots N₁ (hatched circles) of a light sensitive semiconductor material are deposited in a uniform pattern on a metallic substrate S by the tip of a probe of a STM. The selected precursor gases and their mixing ratio in the atmosphere of the precipitation chamber determine the composition of the precipitated nano-dots and, therefore, the band gap E_{g} or spectral sensitivity. Thereafter, the composition of the precursor gases in the atmosphere is changed, for instance by changing the proportion of the precursor gas with the appropriate material component, such that the precipitation now leads to second nano-dots N₂ (white circles) with the same chemical compound as for the first nano-dots N₁ but with a different mixing ratio of the individual material components and, hence, to a different band gap. Under these conditions, the new nano-dots N₂ are thus grown on the substrate S at uniformly disposed positions (FIG. 2b). In a third stage the percentage composition of the gas mixture in the atmosphere is altered again in order at appropriately interspersed position on the substrate S to form third nano-dots N₃ (black circles) with a band gap again shifted. In a terminal structuring stage with a scanning tunnel microscope the intermediate spaces between the nano-dots N₁, N₂, N₃ on the substrate are oxidized in an oxygen-containing atmosphere into an insulator IS (FIG. 2d, grey shading). By applying the p-conductive chalco-pyrite nano-dots on a metallic substrate, Schottky contact photo diodes PD are formed. Three different photo diodes PD, each with a different spectral sensitivity, were structured which applied, for instance, on a flexible substrate may be used as an artificial retina for the human eye which requires light sensors in the range of several micrometers. Yet smaller lateral dimensions of 1o nm and below can be realized.

However, there may be many different fields of application for such spectrally sensitive photo diode arrays SPA. Other opto-electronic components, especially nano-structured ones of a substantially arbitrarily composed or changeable material structure, may be easily fabricated by the method in accordance with the instant invention.

What is claimed is:

1-10. (canceled)

11. A method of fabricating a nano-scaled semiconductor, comprising the steps of:
providing a substrate;
aligning a movable tip of the probe of a scanning electron microscope relative to the substrate;
utilizing a temperature and pressure controlled atmosphere of a mixture of a plurality of precursor gases of an adjustable mixing ratio, each containing a precursor compound of a different material component;
providing as a function of voltage and time a spatially limited electric field between the tip and the substrate to break down the precursor compounds to release their respective different material components for forming and precipitating a common chemical compound as a semiconductor on the substrate.

12. The method of claim 11, wherein the precursor gases are utilized simultaneously.

13. The method of claim 11, wherein the precursor gases are utilized sequentially.

14. The method of claim 11, wherein the material components are selected from the group consisting of at least one element of chemical groups V and VI and of at least one element of chemical groups I, II, III and IV.

15. The method of claim 14, wherein the element of chemical groups V and VI is tellurium and the element from groups I, II, III, and IV is cadmium reacting into the chemical compound cadmium telluride semiconductor.

16. The method of claim 14, wherein the compound semiconductor comprises a chalco-pyrite from the material system of (Cu, Ag) (Ga, In, Al) (O, S, Se)₂.

17. The method of claim 11, wherein the use of at least one of the precursor gases and the mixing ratio thereof in the gas mixture is chronologically varied during precipitation.

18. The method of claim 11, further including the step of utilizing a computer for determining and controlling all parameter variations as a function of the precipitated common chemical compound.

19. The method of claim 11, wherein the substrate is flexible.

20. The method of claim 11, further including the step of incrementally moving the tip.

21. The method of claim 17, wherein the precipitated common chemical compounds vary in spectral sensitivity.

22. The method of claim 21, wherein the spectral sensitivity of the chemical compound varies between the primary colors of red, green and blue.

23. The method of claim 20, further including the step of precipitating the common chemical compound in synchronism with the movement of the tip.

24. The method of claim 23, further comprising the step of placing a semiconductive cover layer between individual common chemical compounds.

25. The method of claim 24, wherein the cover layer is an insulating layer.

26. The method of claim 25, wherein the insulating layer is of a charge conductivity opposite that of the individual common chemical compounds.

27. A semiconductor element fabricated by the method of claim 26, comprising an array of a plurality of precipitated micro-dots forming at least one of a plurality of photo diodes and light emitting diodes.

28. The semiconductor of claim 27, wherein the array comprises a regularly repeating pattern of at least one of the plurality of photo diodes and light emitting diodes.

29. The semiconductor of claim 27, further comprising a semiconductive cover layer of a charge conductivity opposite that of the photo diodes and light emitting diodes is provided between individual photo diodes and light emitting diodes.
